(19) United States
(12) Patent Application Publication
(10) Pub. No.: US 2015/0106247 A1
(43) Pub. Date: Apr. 16, 2015

(54) SYSTEM AND METHOD FOR PURSUING A VALUE-ADDED TAX (VAT) RECLAIM THROUGH A MOBILE TECHNOLOGY PLATFORM

(71) Applicants: Isaac SAFT, Kfar Neter (IL); Noam GUZMAN, Ramat Hasharon (IL)

(72) Inventors: Isaac SAFT, Kfar Neter (IL); Noam GUZMAN, Ramat Hasharon (IL)

(21) Appl. No.: 14/575,115

(22) Filed: Dec. 18, 2014

Related U.S. Application Data
(63) Continuation-in-part of application No. PCT/IL2014/050201, filed on Feb. 27, 2014.
(60) Provisional application No. 61/917,373, filed on Dec. 18, 2013.
(60) Provisional application No. 61/769,786, filed on Feb. 27, 2013.

(51) Int. Cl. G06Q 40/00

(52) U.S. Cl. CPC G06Q 40/123
USPC 705/31

(57) ABSTRACT

A method and systems for pursuing a potential value-added tax (VAT) reclaim through a mobile device. The method comprises receiving at least one image of a VAT receipt from the mobile device; identifying a geographic location of the mobile device; determining whether the mobile device is or was in a foreign country at the time the image was produced; analyzing, by an optical character recognition processor, the at least one image of the VAT receipt; determining whether the VAT receipt is eligible for a VAT refund based on at least one VAT reclaim rule, wherein the at least one VAT reclaim rule determines eligibility based on at least a country of residence of a user of the mobile device, the geographic location of the mobile device, and the analysis of the at least one image; and upon determining that the VAT receipt is eligible for the VAT refund, generating a reclaim request.

### CROSS-REFERENCE TO RELATED APPLICATIONS

This application claims the benefit of U.S. Provisional Application No. 61/917,373 filed on Dec. 18, 2013, the contents of which are hereby incorporated by reference. This application is a continuation-in-part (CIP) of International Application No. PCT/IL2014/050201 filed on Feb. 27, 2014, now pending, which claims priority from U.S. Provisional Application No. 61/769,786 filed Feb. 27, 2013. The contents of above-mentioned applications are hereby incorporated by reference.

### TECHNICAL FIELD

The present disclosure relates generally to computerized refund platforms, and more specifically to systems and methods for processing VAT reclaims through mobile devices.

### BACKGROUND

The Value Added Tax, or VAT, is a broadly based consumer tax assessed on the value added to goods and services. It applies more or less to all goods and services that are bought and sold for use or consumption in a community. It should be noted that, even when a person can claim a refund of a VAT, the person is nevertheless required to pay the VAT at the point of purchase and subsequently reclaim the VAT paid retroactively.

The laws and regulations of many countries allow foreign travelers the right for reimbursement or a refund of certain taxes such as, e.g., VATs paid for goods and/or services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may claim for a refund even though they are not eligible. This procedure further unnecessarily wastes time if the traveler ultimately learns that he or she is not entitled to a refund. It would therefore be advantageous to provide a solution that would overcome the deficiencies of the prior art by providing an effective way to handle VAT refunds electronically and, preferably, over the Internet.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain exemplary embodiments of the disclosure include a method pursuing a potential value-added tax (VAT) reclaim through a mobile device. The method comprising receiving at least one image of a VAT receipt from the mobile device; identifying at least one geographic location of the mobile device; determining whether the mobile device is in a foreign country or was in a foreign country; analyzing, by an optical character recognition processor, the at least one image of the VAT receipt; determining whether the VAT receipt is eligible for a VAT refund based on at least one VAT reclaim rule, wherein the at least one VAT rule determines eligibility based on at least a country of residence of a user of the mobile device, the geographic location of the mobile device, and the analysis of the at least one image; and upon determining that the VAT receipt is eligible for the VAT refund, generating a reclaim request.

Certain exemplary embodiments of the disclosure include a system for pursuing a potential value-added tax (VAT) reclaim through a mobile device. The system comprising a processing system; and a memory communicatively connected to the processing system, the memory containing instructions that, when executed by the processing system, configure the system to: receive at least one image of a VAT receipt from the mobile device; identify a geographic location of the mobile device; determine whether the mobile device is in a foreign country or was in a foreign country; analyze, by the optical character recognition processor, the at least one image of the VAT receipt; determine whether the VAT receipt is eligible for a VAT refund based on at least one VAT reclaim rule, wherein the at least one VAT rule determine eligibility based on at least a country of residence of a user of the mobile device, the geographic location of the mobile device, and the analysis of the at least one image; and upon determining that the VAT receipt is eligible for the VAT refund, generate a reclaim request.

Certain exemplary embodiments of the disclosure include a system for pursuing a potential value-added tax (VAT) reclaim through a mobile device. The system comprising an optical recognition processor for analyzing at least an image of a VAT receipt; a location-based communication analyzer for identifying a location of the mobile device; a VAT eligibility analyzer for determining whether the VAT receipt is eligible for a VAT refund, wherein the VAT eligibility is determined based on at least one reclaim rule set respective of the geographical location of the mobile device; and means for generating a reclaim request upon determining the VAT eligibility.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system for providing potential value added tax (VAT) reclaims according to an embodiment;

FIG. 2 is a flowchart illustrating completing a potential VAT reclaim by a mobile device according to an embodiment; and

FIG. 3 is a flowchart illustrating a method for providing VAT reclaim requests to refund agencies according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for identifying potential value added tax (VAT) reclaims. The method includes registering a host of a mobile device that is equipped with at least one sensor configured to capture at least one image of a VAT receipt. The location (i.e. country) of the mobile device may be identified in real-time by, for example, a global positioning system (GPS) or retroactively by, for example, analyzing a roaming bill of the mobile device, a log on the mobile device, and so on. Respective of the location of the mobile device at the time the at least one image was captured/generated, it is determined whether a user of the mobile device is or was in a foreign country. Each VAT receipt is analyzed to identify whether the VAT receipt is an eligible foreign VAT receipt potential for VAT refund in the foreign country. According to one embodiment, the eligible foreign VAT receipt is submitted to an appropriate refunding agency, such as, a tax authority of the foreign country, an accountant, and so on.

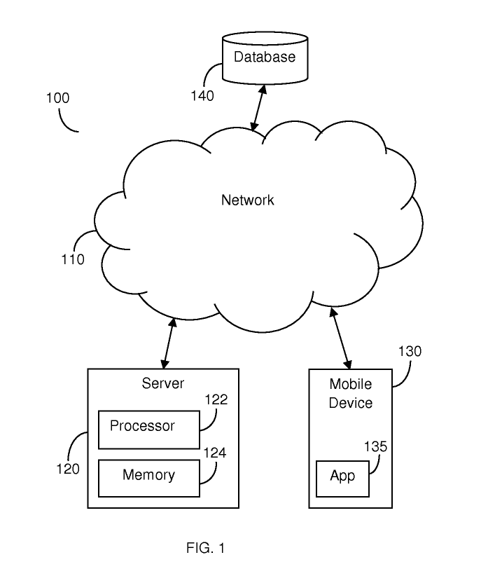

FIG. 1 shows an exemplary and non-limiting schematic diagram of a network system 100 utilized for processing VAT refunds according to an embodiment. The network system 100 include a server 120 and a mobile device 130 communicatively connected to a network 110. The network 110 can be a local area network (LAN), a wide area network (WAN), a metro area network (MAN), the worldwide web (WWW), the Internet, implemented as wired and/or wireless networks, and any combinations thereof.

The server 120 includes a processing system 122 and a memory 124 that contains instructions to be executed by the processing system 122. The processing system 122 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing system 122 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 122 to perform the various functions described herein.

The mobile device 130 may be, but is not limited to, a notebook computer, a cellular phone, a smartphone, a tablet device, a laptop, an in-vehicle infotainment system (IVI), a wearable computing device, and so on. The mobile device 130 is equipped with at least one sensor (not shown) configured to capture at least one image of a VAT receipt. Moreover, the mobile device 130 is configured to execute at least one application (app) 135. Such an application 135 may be, for example, a web browser, a script, or any application programmed to interact with the server 120.

The application 135 is configured to send at least one image of a VAT receipt to the server 120. Each image of a VAT receipt may be, for example, captured by a sensor of the mobile device 130, received through an email, a short message service (SMS), and/or a multimedia messaging service (MMS) of the mobile device 130, or retrieved from a memory unit (not shown) of the mobile device 130. As an example, the image of the VAT receipt may be retrieved from the records of at least one type of expense management system (e.g., Concur®) that the mobile device 130 is equipped with.

It should be noted that only one mobile device 130 and one application 135 are described with respect to FIG. 1 merely for the sake of simplicity. The embodiments disclosed herein are applicable to a plurality of mobile devices 130 that can interact with the server 120 respective of a plurality of applications.

According to an embodiment, the network system 100 includes a database 140. The database 140 may be communicatively connected to the server 120 via the network 110 or part of the server 120. The database 140 maintains information to be used by the server 120 for requesting VAT refunds. As an example, such information may include, but is not limited to, parameters related to the user of the mobile device 130, communication details sent and/or received from the mobile device 130, parameters related to the foreign country, parameters related to the country of origin of the user of the mobile device 130, status of at least one VAT receipt (e.g., “VAT receipt is not eligible for a VAT refund”), and so on.

The server 120 is further configured to use the information maintained in the database 140 to identify whether the VAT receipt is eligible for a VAT refund. In an embodiment, this identification may be based in part on an optical character recognition analysis of the VAT receipt. To this end, in some embodiments, the server 120 may further include or be communicatively connected to an optical character recognition (OCR) processor. According to one embodiment, the eligible foreign VAT receipt is submitted to an appropriate refunding agency through the network 110. Such a refunding agency, may be, but is not limited to, a tax authority, an accountant, and so on.

Upon receiving an image of a VAT receipt by the server 120, the server 120 is configured to search the database 140 to identify whether the VAT receipt is already stored in the database 140 and to identify whether the VAT receipt was previously analyzed. If the image of the VAT receipt is authentic (i.e., was not previously analyzed), the server 120 is configured to analyze the image. The analysis may include identifying whether there are missing, unclear, or otherwise unacceptable parameters identified in the image of the VAT receipt. Such an analysis is described in the above-mentioned International Application No. PCT/IL2014/050201, assigned to common assignee, which is hereby incorporated by reference for all the useful information it contains. If an error is found with respect to the image or the content of the VAT receipt, the server 120 may provide the mobile device 130 with a notification that one or more actions must be taken. The notification is displayed on the mobile device 130 respective of the application 135.

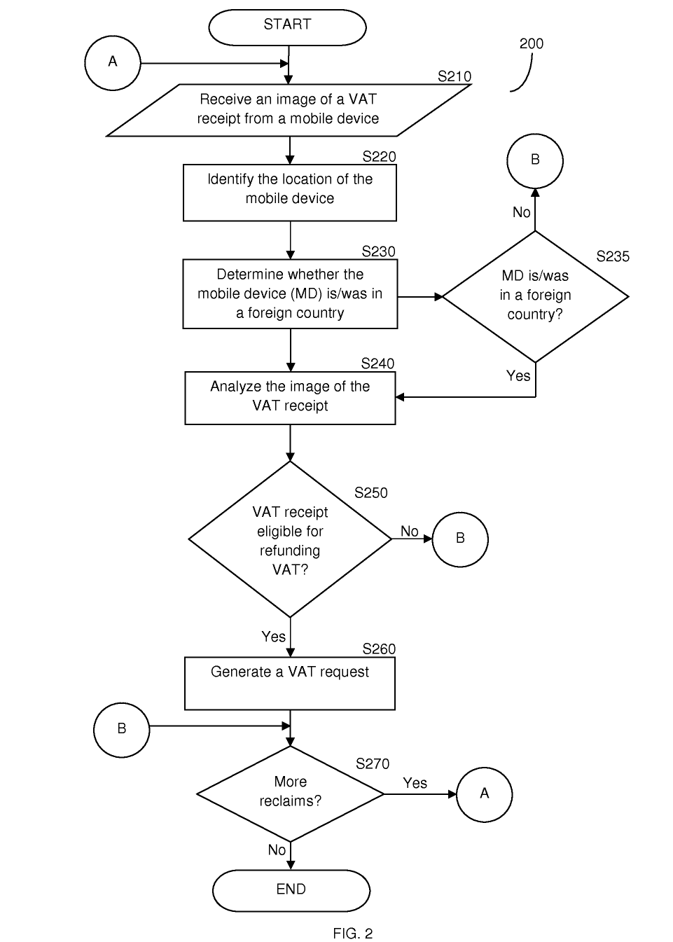

FIG. 2 depicts an exemplary and non-limiting flowchart 200 of a method for processing potential VAT reclaims using a mobile device (e.g., the mobile device 130) according to an embodiment. The mobile device is configured to execute at least one application (e.g., the application 135) that is configured to send at least one image of a VAT receipt to a server (e.g., the server 120). Such an image may be captured by a sensor equipped on the mobile device, received by the mobile device through its email, a short message service (SMS), and/or a multimedia messaging service (MMS), or retrieved from the records of at least one expense management system (e.g., Concur®) that the mobile device is equipped with.

In S210, an image of a VAT receipt is received. According to one embodiment, a notification that one or more action needs to be taken may be provided when the received image is unclear. The notification may be displayed on the mobile device respective of the application. According to another embodiment, an authenticity analysis is performed for the image of the VAT receipt respective of the information stored in a database (e.g., the database 140). The database is searched to identify whether the VAT receipt is already stored in the database and, therefore, was previously processed.

According to yet another embodiment, the image of the VAT receipt is analyzed to identify whether there are one or more missing, unclear, or otherwise unacceptable parameters in the image of the VAT receipt. Upon identifying that the VAT receipt is not authentic, a notification that one or more actions need to be taken may be provided. The notification may be displayed on the mobile device respective of the application. In response to the notification, another image of the same VAT receipt or another VAT receipt may be captured by the sensor or provided by any other suitable means including, but not limited to, through an email, a SMS, and/or MMS, or retrieved from the records of an expense management system.

In S220, the location (e.g., a country) of the mobile device is identified. According to an embodiment, the identification of the location of the mobile device may be performed in real time by, for example, using a global positioning system (GPS). As another example, the identification of the location of the mobile device may be performed in real time based on an analysis of the communication sent to and/or received from the mobile device. According to this example, the server is configured to determine that the location of a picture taken near the Eiffel Tower and uploaded by the mobile device to Facebook® is Paris. According to another embodiment, the identification of the location of the mobile device may be performed retroactively by, for example, analyzing a roaming bill of the mobile device, a log on the mobile device, and so on.

In an embodiment, identification of the location of the mobile device may further include confirming the current and/or past location of the mobile device. Such confirmation may include, but is not limited to, prompting the user to confirm that the location of the mobile device is correct, performing a secondary location identification (e.g., if the initial identification was performed using GPS readings, the secondary location identification may be based on the communication sent to or received from the mobile device), and so on.

In S230, the country of residence (i.e., the country of origin) of the user is determined. Such a determination is performed by using information maintained in the database. As an example, one or more parameters related to the country of origin of the user may be used for the determination. In S235, it is checked whether the mobile device is or was in a foreign country and, if so, execution continues with S240; otherwise, execution continues with S270. In S235, it is checked whether there is a match between the country of origin of the user and the current and/or past location of the mobile device. If there is a match, the mobile device is/was not in a foreign country; if there is no match, the mobile device is in a foreign country.

In S240, the image of the VAT receipt is analyzed to identify whether the VAT receipt is eligible for refunding of VAT in the user's country of residence, or, alternatively, in the foreign country. This is performed by analyzing the information maintained in the database with respect to one or more parameters within the VAT receipt (e.g., a type of purchase, a purchase price, and so on). The information maintained in the database used in the analysis may be, but is not limited to, parameters related to the user, parameters related to the foreign country, parameters related to the country of residence of the user, and parameters related to the country of origin of the user. As an example, it is determined if the VAT receipt complies with laws in the foreign country in which the potential VAT reclaim may be processed. This includes identifying if the VAT receipt supports one or more conditions required in order to receive the VAT refund in the foreign country.

In S250, it is checked whether the VAT receipt is eligible for refunding of VAT and if so, execution continues with S260; otherwise, execution continues with S270. According to an embodiment, a notification that the VAT receipt is not eligible for the refunding of VAT may be sent, for example, to the mobile device, a server of a company (not shown) in which the user of the mobile device is employed (e.g., the notification may be sent to the company's logistics manager), and so on. According to another embodiment, the status of the VAT receipt is updated with respect to information stored in the database (e.g., “the current VAT receipt is not eligible for a VAT refund”)

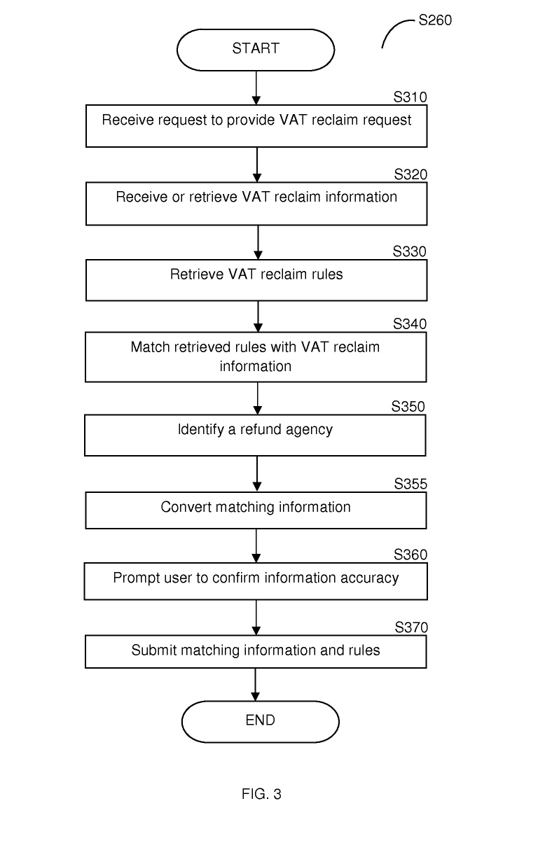

In S260 upon determining that the VAT receipt is eligible for a VAT refund, a reclaim request is generated. Generation of such reclaim request is described further herein below with respect to FIG. 3. The reclaim request may include, but is not limited to, the VAT receipt, a country of origin of the user, a country of residence of the user, and so on. According to an embodiment, the eligible foreign VAT receipt is submitted to an appropriate refunding agency. Such a refunding agency may be, but is not limited to, a tax authority, an accountant, and so on. According to another embodiment, the mobile device and/or the company's logistics manager server is provided with a notification that the process has been successfully completed. Such a notification may be displayed on the mobile device respective of the application. According to yet another embodiment, the image of the VAT receipt may be sent to the database for storage and for further use. In S270, it is checked whether there are additional images of VAT receipts and, if so, execution continues with S210; otherwise, execution terminates.

FIG. 3 is an exemplary and non-limiting flowchart S260 illustrating a method providing reclaim requests to refund agencies according to an embodiment. In S310, a request to provide a reclaim request to a refund agency is received. The refund agency, may be, but is not limited to, a tax authority, an accountant, and so on.

In S320, information related to a potential VAT reclaim is received, for example, from a mobile device (e.g., mobile device 130) or retrieved from a database (e.g., database 140). The received or retrieved information may include, but is not limited to, the current location of the mobile device, the image of the VAT receipt, one or more parameters related to the VAT receipt (e.g., a type of purchase, a purchase price), account information of a user (e.g., a bank account), and information of one or more refund agencies of the foreign country.

In S330, respective of the current location (i.e. foreign) of the mobile device, VAT reclaim rules of the foreign country in which the mobile device is located is retrieved. Such foreign VAT reclaim rules may include, but are not limited to, categories of goods and/or services that may be eligible for VAT refunds in that country, a minimum monetary amount for a VAT refund, identification requirements, and so on.

In S340, each retrieved rule is matched with appropriate information related to the potential VAT reclaim. As non-limiting example, a law regarding a minimum purchase price may be matched to the purchase price of the VAT receipt, a type of purchase may be matched to a category of goods or services allowed to be reclaimed, and so on. In S350, a refund agency for processing the VAT reclaim request is determined respective of the received or retrieved information. In optional S355, the matching information may be converted into a format suitable for insertion into a predetermined reclaim form. In an embodiment, such a suitable format may be an electronic or a digital format. As a non-limiting example, the information may be put into a .xml file that may be imported into a PDF form.

In S360, a user may be prompted to confirm the accuracy of all matching information. In an embodiment, S360 may also involve allowing a user to modify the information related to the potential VAT reclaim. In S370, the matching information is submitted to the refund agency. In an embodiment, the matching information may be submitted in the suitable format. In another embodiment, the matching information may be submitted automatically to a data warehouse of the refund agency. In a further embodiment, such matching information may be submitted via a website of the refund agency. The automatic electronic submission of the VAT reclaim request may be particularly useful when the user is traveling if the user may not be easily able to submit such a request due to, e.g., time constraints, particularly when the user is anticipating boarding an airplane.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for pursuing a potential value-added tax (VAT) reclaim through a mobile device, comprising:
receiving at least one image of a VAT receipt from the mobile device;
identifying a geographic location of the mobile device;
determining whether the mobile device is in a foreign country;
analyzing, by an optical character recognition processor, the at least one image of the VAT receipt;
determining whether the VAT receipt is eligible for a VAT refund based on at least one VAT reclaim rule, wherein the at least one VAT rule determines eligibility based on at least a country of residence of a user of the mobile device, the geographic location of the mobile device, and the analysis of the at least one image; and
upon determining that the VAT receipt is eligible for the VAT refund, generating a reclaim request.

2. The computerized method of claim 1, further comprising:
submitting the eligible foreign VAT receipt and the generated reclaim request to an appropriate refunding agency.

3. The computerized method of claim 1, wherein the geographic location of the mobile device is identified by using at least one of: global positioning system (GPS) coordinates provided by the mobile device, communication protocol messages received or sent by the mobile device.

4. The computerized method of claim 1, wherein determining whether the mobile device is in the foreign country is based on at least information maintained in a database.

5. The computerized method of claim 4, wherein the information maintained in the database includes at least one of: at least one parameter related to the user, at least one parameter related to the foreign country, and at least one parameter related to the country of residence of the user.

6. The computerized method of claim 1, further comprising:
determining whether there is at least one error in the at least one image of the VAT receipt;
upon determining that there is at least one error in the at least one image of the VAT receipt, sending, to the mobile device, a notification that at least one action needs to be taken.

7. The computerized method of claim 6, wherein the at least one error is at least one of: missing information and a blurred image.

8. The computerized method of claim 1, further comprising:
confirming the identified geographic location of the mobile device.

9. A non-transitory computer readable medium having stored thereon instructions for causing one or more processing units to execute the method according to claim 1.

11. A system for pursuing a potential value-added tax (VAT) reclaim through a mobile device, comprising:
a processing system; and
a memory communicatively connected to the processing system, the memory containing instructions that, when executed by the processing system, configure the system to:
receive at least one image of a VAT receipt from the mobile device;
identify a geographic location of the mobile device;
determine whether the mobile device is in a foreign country;
analyze, by the optical character recognition processor, the at least one image of the VAT receipt;
determine whether the VAT receipt is eligible for a VAT refund based on at least one VAT reclaim rule, wherein the at least one VAT rule determine eligibility based on at least a country of residence of a user of the mobile device, the geographic location of the mobile device, and the analysis of the at least one image; and
upon determining that the VAT receipt is eligible for the VAT refund, generate a reclaim request.

12. The system of claim 11, wherein the system is further configured to:
submit the eligible foreign VAT receipt and the generated reclaim request to an appropriate refunding agency.

13. The system of claim 11, wherein the geographic location of the mobile device is identified by using at least one of: global positioning system (GPS) coordinates provided by the mobile device, and communication protocol messages received or sent by the mobile device.

14. The system of claim 13, wherein the system is further configured to query a database to determine whether the mobile device is in a foreign country.

15. The system of claim 14, wherein the information maintained in the database includes at least one of: at least one parameter related to the user, at least one parameter related to the foreign country, and at least one parameter related to the country of origin of the user.

16. The system of claim 11, wherein the system is further configured to:
determine whether there is at least one error in the at least one image of the VAT receipt;
send to the mobile device a notification that at least one action needs to be taken, upon determining that there is at least one error in the at least one image of the VAT receipt.

17. The system of claim 16, wherein the at least one error is at least one of: missing information and a blurred image.

18. The system of claim 11, wherein the system is further configured to:
confirm the identified geographic location of the mobile device.

19. The system of claim 11, wherein the processing system comprises at least an optical recognition processor.

20. A system for pursuing a potential value-added tax (VAT) reclaim through a mobile device, comprising:
an optical recognition processor for analyzing at least an image of a VAT receipt;
a location-based communication analyzer for identifying a location of the mobile device;
a VAT eligibility analyzer for determining whether the VAT receipt is eligible for a VAT refund, wherein the VAT eligibility is determined based on at least one reclaim rule set respective of geographical location of the mobile device; and
means for generating a reclaim request upon determining the VAT eligibility.
